(19) United States
(12) Patent Application Publication
(10) Pub. No.: US 2015/0286793 A1
(43) Pub. Date: Oct. 8, 2015

(54) SYSTEM AND METHOD FOR SLEEP APNEA ASSESSMENT

(71) Applicant: University Health Network, Toronto (CA)

(72) Inventor: FONG-TING CHUNG, TORONTO (CA)

(21) Appl. No.: 14/677,465

(22) Filed: Apr. 2, 2015

Related U.S. Application Data
(60) Provisional application No. 61/974,319, filed on Apr. 2, 2014.

(51) Int. Cl. G06F 19/00

(52) U.S. Cl. CPC G06F 19/3431; G06F 19/363

(57) ABSTRACT

A computer system and method for determining an appropriate risk group of having obstructive sleep apnea (OSA) for an individual are disclosed. The system includes: an electronic data store storing a plurality of user profiles and a questionnaire; an input means for receiving one or more user inputs from a user related to the questionnaire; and an analytics module configured to determine if the user is obese or not based on the one or more user inputs, and further to determine the appropriate risk group of having OSA for the user based on the one or more user inputs.

### CROSS-REFERENCE TO RELATED APPLICATION

This non-provisional application claims the benefit of and priority from U.S. Provisional Patent Application No. 61/974,319 filed Apr. 2, 2014, the entirety of which is incorporated herein by reference.

### FIELD

Embodiments described herein relate generally to systems and methods for managing sleep apnea. The present invention further relates to a computer network system and method that are configured to facilitate identification of obstructive sleep apnea.

### BACKGROUND

Generally speaking, sleep apnea may be an event of paused breathing or a marked reduction in airflow (hypopnea) during sleep, and can pose health risks to individuals who are considered obese. Sleep apnea can be considered clinically relevant if an episode lasts more than 5-10 seconds.

Obstructive sleep apnea (OSA) can be a moderate to severe form of sleep-breathing disturbance, affecting both men and women in the general population. OSA may cause many inconveniences and health risks to individuals, such as: desaturation and arousals from sleep, excessive daytime sleepiness, poor concentration and fatigue during daytime, and so on.

In addition, OSA has known associations with several medical conditions or diseases such as:
(a) cardiovascular disease (acute myocardial infarction, heart failure, arrhythmias, hypertension);
(b) cerebrovascular disease;
(c) metabolic syndrome;
(d) gastro-esophageal reflux disease; and
(e) obesity.

It is often quite hard for someone with possible OSA symptoms to determine if he or she indeed has OSA or not. OSA can affect people in all age groups¹ and has been said to affect 2-26% of the general population.^{2,3} It is estimated that over 80% of men and 90% of women with moderate-to severe OSA have not been diagnosed.⁴⁻⁶

One reason behind the low rate of identification of OSA may be that in today's fast-paced society, most people tend not to visit a doctor or clinic simply due to sleep apnea symptoms. Even at hospitals and clinics, it is often a cumbersome process to assess if someone is at risk for having OSA, often in conjunction with investigating or diagnosing of some other forms of medical conditions.

Therefore improved solution is required to address the above-mentioned problems.

### SUMMARY

In accordance with one aspect of the invention, a computer system for determining an appropriate risk group of having obstructive sleep apnea (OSA) for an individual is disclosed, the system includes: an electronic data store storing a plurality of user profiles and a questionnaire; an input means for receiving one or more user inputs from a user related to the questionnaire; and an analytics module configured to determine if the individual is obese or not based on the one or more user inputs, and further to determine the appropriate risk group of having OSA for the individual based on the one or more user inputs.

In another aspect, the computer system includes a client portal module configured to retrieve one or more parameters and/or one or more determinations of risk group of the individual.

In yet another aspect, one of the one or more user inputs relates to a body mass index (BMI) and the analytics module is configured to determine if the individual is obese or not obese based on if said one of the one or more user inputs has a value greater than a pre-determined threshold.

In still another aspect, a risk level for the appropriate risk group may be one of: a low risk, a high risk, and a very high risk.

In one aspect, the analytics module may be configured to determine the appropriate risk group of having OSA based on a total number of affirmative answers in the one or more user inputs to the questionnaire received by the input means.

In another aspect, the questionnaire may include one or more of the following questions:
(a) Do you Snore Loudly (loud enough to be heard through closed doors or your bed-partner elbows you for snoring at night)?
(b) Do you often feel Tired, Fatigued, or Sleepy during the daytime (such as falling asleep during driving)?
(c) Has anyone Observed you Stop Breathing or Choking/Gasping during your sleep? (d) Do you have or are being treated for High Blood Pressure?
(e) Is your Body Mass Index (BMI) more than 35 kg/m²?
(f) Is your Age older than 50 year old?
(g) Neck size (measured around Adams Apple): For male, is your shirt collar 17 inches or larger? For female, is your shirt collar 16 inches or larger?
(h) Is your Gender Male?

In another aspect, a set of STOP questions stored in the electronic data store may include one or more of the following questions:
(a) Do you Snore Loudly (loud enough to be heard through closed doors or your bed-partner elbows you for snoring at night)?
(b) Do you often feel Tired, Fatigued, or Sleepy during the daytime (such as falling asleep during driving)?
(c) Has anyone Observed you Stop Breathing or Choking/Gasping during your sleep?
(d) Do you have or are being treated for High Blood Pressure?

In still another aspect, if the one or more user inputs indicate that the individual is not classified as obese, the appropriate risk group is determined to be a group of very high risk of OSA if the one or more user inputs comprise: (1) affirmative answers to 5 to 8 of the questions in the questionnaire; (2) affirmative answers to 2 or more of the STOP questions and the one or more user inputs indicate that the individual's gender is male; or (3) affirmative answers to 2 or more of the STOP questions, and the one or more user inputs indicate that the individual's BMI is greater than 35 kg/m2.

If the appropriate risk group is not determined to be the group of very high risk of OSA, then the appropriate risk group is determined to be a group of: low risk of OSA if the one or more user inputs comprise affirmative answers to 0 to 2 questions in the questionnaire; or high risk of OSA if the one or more user inputs comprise affirmative answers to 3 or 4 questions in the questionnaire.

In one aspect, if the one or more user inputs indicate that the individual is classified as obese, the appropriate risk group is determined to be a group of: very high risk of OSA if the one or more user inputs comprise: (1) affirmative answers to 6 to 8 of the questions in the questionnaire; or (2) affirmative answers to 2 or more of the STOP questions and the one or more user inputs indicate that the individual's gender is male.

If the appropriate risk group is not determined to be the group of very high risk of OSA, then the appropriate risk group is determined to be a group of: low risk of OSA if the one or more user inputs comprise affirmative answers to 0 to 3 questions in the questionnaire; or high risk of OSA if the one or more user inputs comprise affirmative answers to 4 or 5 questions in the questionnaire.

In yet another aspect, the analytics module classifies the individual as obese if the one or more user inputs indicate that the individual's BMI is greater than 35 kg/m².

In accordance with an aspect of the present invention there is provided a computer-implemented method for determining an appropriate risk group of having obstructive sleep apnea (OSA) for an individual, the method being performed by a processor, the processor in communication with a client application over a communication network, the method comprising: (a) receiving, over the communication network, one or more user inputs in response to a questionnaire from the client application; (b) determining if the individual is obese or not obese based on the one or more user inputs; and (c) determining the appropriate risk group of having OSA for the individual based on the one or more user inputs.

In another aspect of the invention, at least one user profile for the individual is stored in the electronic data store.

In another aspect of the invention, determining if the individual is obese or not is based on if the one or more user inputs indicate that the individual has a body mass index greater than a pre-determined threshold.

In yet another aspect of the invention, a risk level for the appropriate risk group may be one of: a low risk, a high risk, and a very high risk.

In still another aspect of the invention, determining the appropriate risk group of having OSA is based on a total number of affirmative answers to the questionnaire received by the processor from the client application.

In one aspect of the invention, a method of assessing risk of OSA in an individual is provided, the method comprising: (a) receiving one or more user inputs to a questionnaire; and (b) determining the appropriate risk group for the individual based on the one or more user inputs.

In another aspect of the invention, the questionnaire comprises questions:
(a) Do you Snore Loudly (loud enough to be heard through closed doors or your bed-partner elbows you for snoring at night)?
(b) Do you often feel Tired, Fatigued, or Sleepy during the daytime (such as falling asleep during driving)?
(c) Has anyone Observed you Stop Breathing or Choking/Gasping during your sleep? (d) Do you have or are being treated for High Blood Pressure?
(e) Is your Body Mass Index (BMI) more than 35 kg/m²?
(f) Is your Age older than 50 year old?
(g) Neck size (measured around Adams Apple): For male, is your shirt collar 17 inches or larger? For female, is your shirt collar 16 inches or larger?
(h) Is your Gender Male?

In yet another aspect of the invention, the questions (a), (b), (c) and (d) in the questionnaire above can be considered to be STOP questions.

In yet another aspect of the invention, determining the appropriate risk group of having OSA for the individual based on the one or more user inputs comprises:
(a) if the individual is not classified as obese, the appropriate risk group is determined to be a group of:
   very high risk of OSA if the one or more user inputs comprise:
      1) affirmative answer to 5 to 8 of the questions in the questionnaire;
      2) affirmative answer to 2 or more of the STOP questions and the individual's gender is male; or
      3) affirmative answer to 2 or more of the STOP questions, and the individual's BMI is greater than 35 kg/m²;
   If the appropriate risk group is not determined to be the group of very high risk of OSA, then the appropriate risk group is determined to be a group of:
   low risk of OSA if the one or more user inputs comprise affirmative answer to 0 to 2 of the questions in the questionnaire; or
   high risk of OSA if the one or more user inputs comprise affirmative answer to 3 or 4 of the questions in the questionnaire;
(b) if the individual is classified as obese, the appropriate risk group is determined to be a group of:
   Very high risk of OSA if the one or more user inputs comprise:
      1) affirmative answer to 6 to 8 of the questions in the questionnaire; or
      2) affirmative answer to 2 or more of the STOP questions and the individual's gender is male;
   If the appropriate risk group is not determined to be the group of very high risk of OSA, then the appropriate risk group is determined to be a group of:
   low risk of OSA if the one or more user inputs comprise affirmative answer to 0 to 3 of the questions in the questionnaire; or
   high risk of OSA if the one or more user inputs comprise affirmative answer to 4 or 5 of the questions in the questionnaire.

In still another aspect of the invention, the individual is classified as obese if his or her BMI is greater than 35 kg/m².

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1 illustrates an exemplary system network diagram in accordance with an aspect of the invention.

FIG. 2 illustrates an exemplary system diagram in accordance with an aspect of the invention.

FIG. 3 illustrates an exemplary workflow chart in accordance with an aspect of the invention.

FIG. 4 illustrates an exemplary computer device that may be used as a server platform in accordance with an aspect of the invention.

### DETAILED DESCRIPTION

Features of the systems, devices, and methods described herein may be used in various combinations, and may also be used for the system and non-transitory computer-readable storage medium in various combinations.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or a combination thereof, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may transform electronic signals of various data objects into three dimensional representations for display on a tangible screen configured for three dimensional displays. One should appreciate that the systems and methods described herein involve interconnected networks of hardware devices configured to receive data using receivers, transmit data using transmitters, and transform electronic data signals for various three dimensional enhancements using particularly configured processors, where the three dimensional enhancements are for subsequent display on three dimensional adapted display screens.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Disclosed herein is a system, comprising at least a client application 100 and a server platform or simply “platform” 14, that can be configured to record, analyze and identify sleep apnea in one or more individuals and thus help the individuals with health decision-making. It can enable users to self-identify relatively quickly if he or she may be in a high risk of group of people who likely have OSA.

In one aspect, the system and related method embody a screening tool for the assessment or identification of obstructive sleep apnea (OSA). It can be used by individuals with no medical background, at any place with a network connection or in an offline mode. It can also be used in various clinical or hospital settings, e.g. preoperative clinic, sleep clinic, and various other clinics or areas where patients may be assessed or evaluated.

It can further be used as a screening tool by physicians, nurses and other health care professional for screening of sleep apnea, e.g. anesthesiologists, pulmonary physicians, sleep physicians, cardiologists, dentists, ENT surgeons, family doctors, and so on.

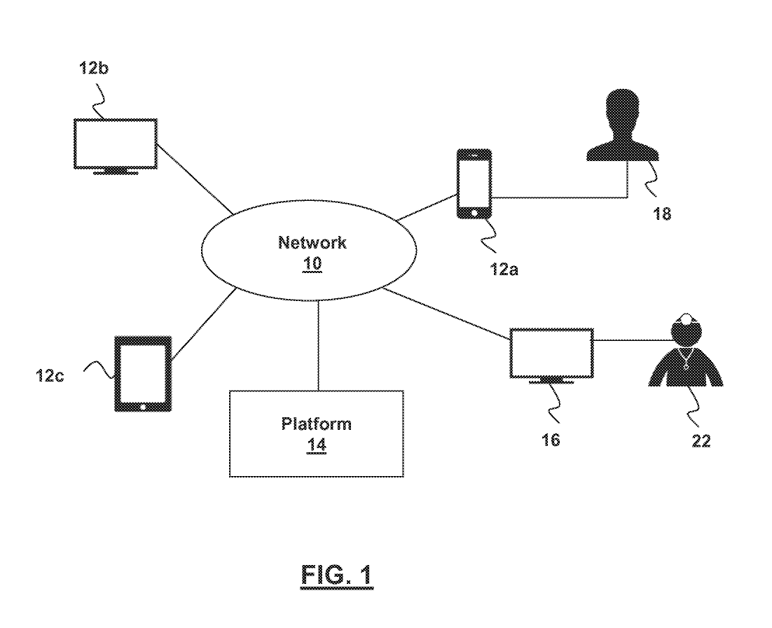

Referring now to FIG. 1, an exemplary system network diagram in accordance with an aspect of the invention is shown. Network 10 may be one or more networks in any suitable form, including as a local area network or a wide area network, such as an enterprise network or the Internet. Such networks may be based on any suitable technology and may operate according to any suitable protocol and may include wireless networks, wired networks or fiber optic networks.

It is to be appreciated that even though a mobile device such as a phone or a tablet may be illustrated in the drawings and referred to in the description, they may also be substituted with any type of computing device capable of providing the functionalities described herein. For example, a mobile phone may also be a tablet device or a desktop device, and vice versa.

Mobile device 12a (e.g. iPhone™ or Android™ device) or other types of computing device 12b, 12c can provide one or more users 18 access to a OSA Survey Client Application 100. A Client Portal 230 may also be available to retrieve one or more parameters and/or one or more determinations of risk group of a user or individual.

OSA Survey Client Application 100 may be particularly configured with hardware and software to interact with Platform 14 via network 10 to implement the functionalities described herein. For simplicity only one mobile device 12 is shown but system may include one or more mobile devices 12 operable by users or patients to access remote network resources. OSA Survey Client Application 100 may be implemented using one or more processors and one or more data storage devices configured with database(s) or file system(s), or using multiple devices or groups of storage devices distributed over a wide geographic area and connected via a network (which may be referred to as “cloud services”).

OSA Survey Client Application 100 and Platform 14 may reside on any networked computing device, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these.

Platform 14 may include any type of processor, such as, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Platform 14 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each of Platform 14 and OSA Survey Client Application 100 may include one or more input devices, such as a keyboard, mouse, camera, touch screen, sensors, and a microphone, and may also include one or more output devices such as a display screen (with three dimensional capabilities) and a speaker. OSA Survey Client Application 100 and Platform 14 may each has a network interface in order to communicate with other components, to access and connect to network resources, to serve an application and other applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. OSA Survey Client Application 100 and Platform 14 can be operable to register and authenticate users (using a login, unique identifier, and password for example) prior to providing access to applications, a local network, network resources, other networks and network security devices. In addition, Platform 14 may serve one user or multiple users.

OSA Survey Client Application 100 and Platform 14 can work in an inter-operative manner to enable users 18 to self-identify as high or low risk of having OSA via completion of a short questionnaire. Platform 14 can analyze a variety of data and generate intelligent reports to create and inform recommendations for users 18 and health professionals 22.

Platform 14 can be further operable to provide a client portal interface, which a user 18 may access to obtain intelligent individual reports based on at least his or her historical usage of OSA Survey Client Application 100. The client portal interface may be a web-based interface and hosted by cloud or at Platform 14.

User 18 may be any individual that is curious about if he (or she) or someone else may be at risk for having OSA. For example, user 18 may be a person who has had trouble sleeping at night and barely has time to see a doctor. For another example, user 18 may be wife of someone who has recently begun snoring quite loudly at night. Users 18 can download and install OSA Survey Client Application 100 from an app store (e.g. Apple™ or Android™ app store) onto his or her device 12. The device 12 may be a mobile device 12a, a tablet device 12b, or a desktop computer 12c. Alternatively or concurrently, the OSA Survey Client Application 100 may be accessible by users 18 via devices 12 online at a web portal hosted by Platform 14.

Physicians or health professionals 22 may also connect to the Platform 14 via a device 16. Even though device 16 is illustrated as a desktop computer, it may also be a mobile or tablet device.

In one embodiment of the invention, Platform 14 may be implemented by a computer server system 200, described below.

In another embodiment of the invention, Platform 14 may be implemented as a cloud service, a cluster service or simply a cluster hosted in cloud, or a router server configured based on certain configurations.

In one embodiment of the invention, Platform 14 may be remotely or closely coupled with one or more OSA Survey Client Application 100 on one or more mobile devices 12, and comprise entirely of software, or entirely of hardware, or include both software and hardware components. Platform 14 may be implemented to one or more server computers, or may be implemented as an interconnected network of computer residing at the same or different physical locations, and connected to one or more OSA Survey Client Application 100 and the core network through one or more trusted network connections. OSA Survey Client Application 100 can interoperate with Platform 14 and/or other components (e.g. client portal module 230) in the network architecture in order to deliver the functionalities described herein.

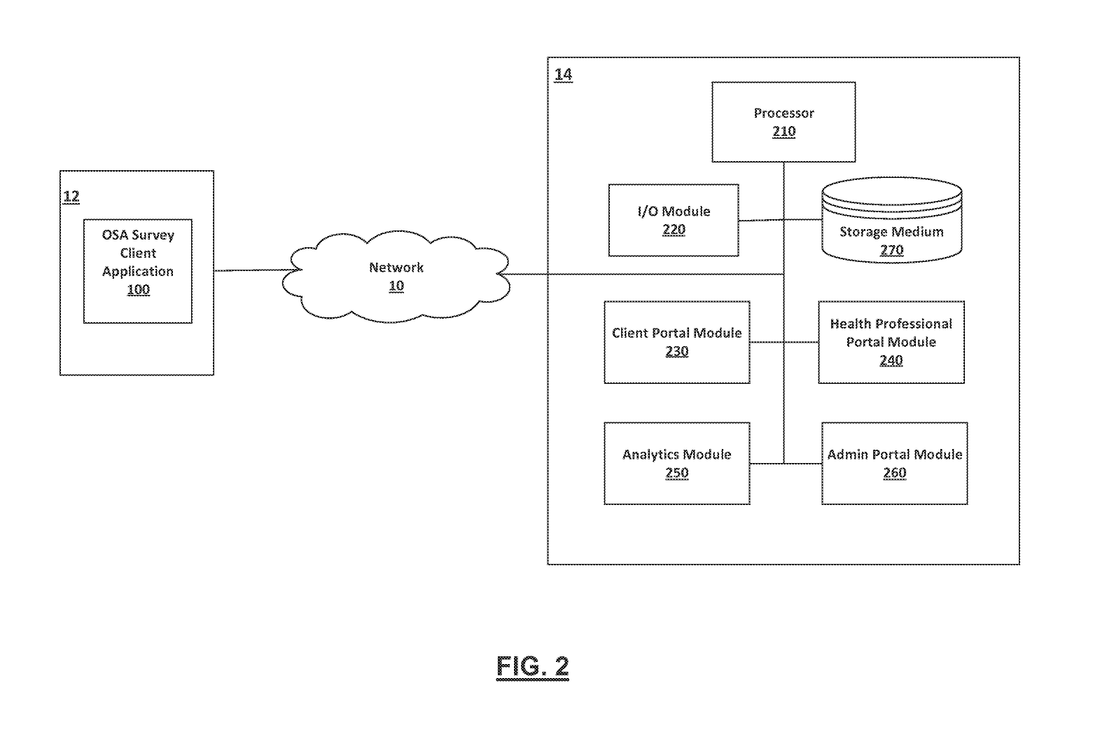

FIG. 2 illustrates an exemplary system diagram in accordance with one aspect of the invention. In one embodiment of the invention, OSA Survey Client Application 100 can be installed on Mobile device 12 and connect to Platform 14 via Network 10.

### OSA Survey Client Application 100

OSA Survey Client Application 100 can be operable to receive input from users 18 and to store the received information in an electronic database, either in a local memory on the device 12 or in a remotely connected database, such as a non-transitory storage medium 270 of Platform 14. The input may be then sent to an Input/Output (I/O) Module 220 and an Analytics Module 250 of Platform 14 for further processing and identification of OSA. There may be a variety of health or lifestyle related information collected via an input interface of OSA Survey Client Application 100.

In one aspect of the invention, the input may relate to weight, height, gender, age, blood pressure, workout frequency, marriage status, number of children, and so on. All the information entered by user 18 into OSA Survey Client Application 100 can be stored in a database for further analysis or reporting purposes.

In another aspect of the invention, OSA Survey Client Application 100 can ask a series of yes or no questions in the form of a survey or questionnaire stored in storage medium 270, designed to screen user 18 for very high, high or low risk of OSA. In an exemplary embodiment of the invention, the short questionnaire can comprise the following questions:
(a) Snoring: Do you Snore Loudly (loud enough to be heard through closed doors or your bed-partner elbows you for snoring at night)?
(b) Tired? (Do you often feel Tired, Fatigued, or Sleepy during the daytime? For example, such as falling asleep during driving?)
(c) Observed? (Has anyone Observed you Stop Breathing or Choking/Gasping during your sleep?)
(d) Pressure? (Do you have or are being treated for High Blood Pressure?)
(e) Body Mass Index (BMI) more than 35 kg/m²?
(f) Age older than 50 year old?
(g) Neck size (measured around Adams Apple): For male, is your shirt collar 17 inches or larger? For female, is your shirt collar 16 inches or larger?
(h) Gender=Male?

The first four questions (a) to (d) can also be referred to as “STOP” questions, an abbreviation of Snoring, Tired, Observed and Pressure. These four STOP questions can play a more important role in determining if an individual may be at a high risk of having OSA. That is, in one embodiment of the invention, when evaluating individuals or users based on answers received, these four STOP questions may be given a greater weight in the risk assessment process by Platform 14, as described below.

These four STOP questions may each be stored and tagged appropriately as a high priority question or as a STOP question in storage medium 270.

Questions may be modified or updated from time to time to reflect the latest medical research and conclusions.

In another embodiment of the invention, for question (e) regarding BMI, instead of asking if a BMI is greater than 35 kg/m², OSA Survey Client Application 100 can also ask for specific value(s) of a weight and a height, from which a BMI may be calculated automatically.

In yet another embodiment of the invention, for question (g) regarding neck size, the unit of centimetre is used instead of inches. In still another embodiment of the invention, OSA Survey Client Application 100 may be configured to ask user 18 to choose a neck size of S, M, L or XL.

Once a user 18 has answered all the questions in the questionnaire, for example by clicking on each radio button indicating his or her choice, the answers, in the form of yes or no, along with any associated values (e.g. specific neck size, weight, height or BMI values) may then be communicated to an Input/Output (I/O) Module 220 of Platform 14 for further processing and analyzing. All the inputs may be time stamped.

User 18 may also choose to view stored records of previously answered surveys or questionnaires and their associated results, as determined by the Analytics Module 250 of Platform 14.

In another aspect of the invention, OSA Survey Client Application 100 may include or otherwise connect to an analytics utility or module. The analytics utility may be stored locally or in cloud, for example. The analytics utility may be configured to receive real time or near real time data, optionally store the data in a storage medium, and process or mine the data to determine one or more recommendations or suggestions to user 18 or health professionals 22.

### Platform 14

In one aspect of the invention, Platform 14 can communicate with OSA Survey Client Application 100 to provide a determination for user 18 regarding whether he or she may be a in a high or low risk group for having OSA.

As shown in FIG. 2, in one embodiment of the invention, Platform 14 can have different modules such as processor 210, I/O module 220, client portal module 230, health professional portal module 240, analytics module 250, admin portal module 260, and a non-transitory storage medium 270. The portals may be accessed on any computer device, including in HTML5 format and in a mobile interface friendly way.

Platform 14 can uses in-depth analytics (via e.g. analytics module 250) to determine, based on input from user 18 sent by OSA Survey Client Application 100, if the user 18 may belong to a high or low risk group of having OSA. Analytics module 250 can be further configured to generate insights into user lifestyle or health trend based on historical data such as weight, height, BMI and so on. In addition, raw data from all users 18 can be aggregated in the cloud or in storage medium 270, and machine learning algorithms can be applied to the raw data to generate insights into user lifestyle or health trends. In one embodiment of the invention, the data may be stripped of identifying information prior to be aggregated on cloud or in storage medium 270.

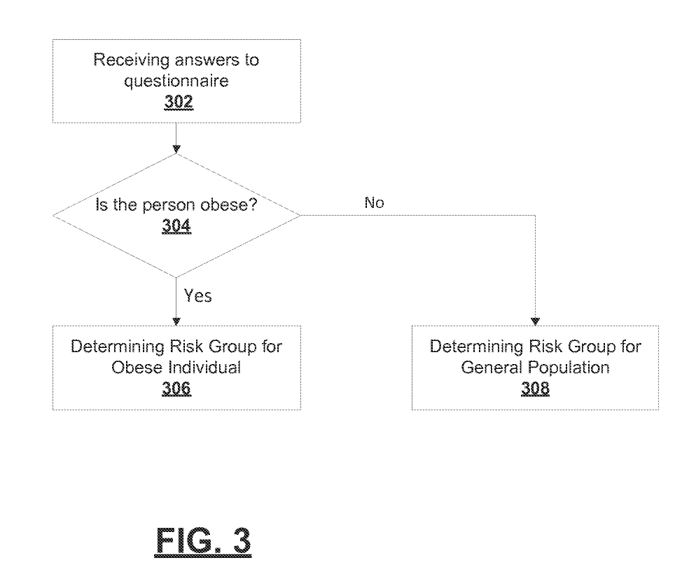

Referring now to FIG. 3, in one embodiment of the invention, analytics module 250 can be configured to identify or classify users 18 into a high or low risk group of having OSA based on a validated logic as follows.

At step 302, analytics module 250 retrieves answers by user 18 to the questionnaire from storage medium 270. Alternatively, it may receive the answers from OSA Client Survey Application 100 directly.

At step 304, based on the BMI, weight, or height information, analytics module 250 may be configured to decide if user 18 should be classified as an obese individual for the purpose of OSA identification. For example, in one embodiment of the invention, user 18 may be considered obese if his or her BMI is greater than 35 kg/m². In another embodiment of the invention, depending on user 18's ethnical or racial background (e.g. Asian or European), he or she may be considered obese if the BMI is greater than 30 kg/m² instead. There may be other ways of determining if a person is obese and any suitable method may be used as long as it is scientifically accurate.

In one embodiment of the invention, if user 18 is not classified as obese, that is, if user 18 belongs to a simplified classification of general population, then analytics module 250 can be configured to look at the number of questions answered in an affirmative manner (i.e., answered with a yes) by user 18 and assess if user 18 may be in a low, high or very high risk group of having OSA in accordance with one set of logic as follows:
(a) Very high risk of OSA:
   1) User 18 answers yes to 5-8 questions;
   2) User 18 answers yes to 2 or more STOP questions AND gender is male; or
   3) User 18 answers yes to 2 or more STOP questions, AND BMI is greater than 35 kg/m²
IF user 18 does not belong to the group of very high risk of OSA, then user 18 may be determined to be in a group of:
(b) Low risk of OSA: User 18 answers yes to 0-2 questions; or
(c) High risk of OSA: User 18 answers yes to 3-4 questions.

On the other hand, if user 18 is classified as obese by a suitable scientific method, then at step 306, analytics module 250 can be configured to look at how many questions have been answered in an affirmative manner (i.e., answered with a yes) by user 18. Analytics module 250 can assess and determine if user 18 may be in a low, high or very high risk group of having OSA based on the affirmative answers (e.g. “yes” or “confirmed”) received, according to a different set of logic below:
(a) Very high risk of OSA:
   1) User 18 answers yes to 6-8 questions; or
   2) User 18 answers yes to 2 or more STOP questions AND gender is male.
IF user 18 does not belong to the group of very high risk of OSA, then user 18 may be determined to be in a group of:
(b) Low risk of OSA: User 18 answers yes to 0-3 questions; or
(c) High risk of OSA: User 18 answers yes to 4-5 questions.

As described above, in one embodiment of the invention, user 18 can be classified as obese if his or her BMI is greater than 35 kg/m².

Once analytics module 250 has determined if user 18 is in a group of people who may be at a low, high or very risk of having OSA, it may send the determination of risk group, and optionally one or more parameters related to the determination, via OSA Survey Client Application 100 to user 18. The one or more parameters may be, for example, that user 18 is classified as an obese individual. The parameters may also contain information entered by user 18 during the course of answering one or more questionnaires.

The determination of risk group and the one or more parameters may be stored in storage medium 270.

In one embodiment of the invention, client portal module 230 may be configured to retrieve one or more parameters, and one or more determinations of risk group, of user 18 from records stored in storage medium 270 and to display the information at a client portal interface. User 18 may log into his or her profile at the client portal interface and browse all the historical data, including questionnaires answered and associated determination or results.

In another embodiment of the invention, health professional portal module 240 may be configured to retrieve and display aggregate, identity-stripped data relating to one or more questionnaires and associated user inputs to authorized health professional users 22.

In yet another embodiment of the invention, one or more health professionals 22 may be authorized by a user 18 to access his or her health record, or a subset of health record, including the questionnaires and associated user inputs. In this case, the health professional 22 may log into the health professional portal interface online, and view the health record data of users 18 who have given permission to or otherwise authorized the health professional 22 to do so. In turn, the health professional 22 may be able to recommend an appropriate treatment or other forms of medical device tailored to the user 18 based on his or her health condition as reflected by the health record.

Admin portal module 260 can be configured to enable administrative users to modify or delete any survey or questionnaire as needed. It may also be configured to set or reset authorization settings for one or more users 18 or health professionals 22.

The functionality described herein may also be accessed as an Internet service, for example by accessing the functions or features described from any manner of computer device, by the computer device accessing a server computer, a server farm or cloud service configured to implement said functions or features.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. A processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including an EGM, A Web TV, a Personal Digital Assistant (PDA), a smart phone, a tablet or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, a computer may receive input information through speech recognition or in other audible formats.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The system and method may be embodied as a tangible, non-transitory computer readable storage medium (or multiple computer readable storage media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer-readable storage media) encoded with one or more programs that, when executed on one or more computers or other processors, perform methods that implement the various embodiments discussed above. The computer readable medium or media can be transportable, such that the program or programs stored thereon can be loaded onto one or more different computers or other processors to implement various aspects as discussed above. As used herein, the term “non-transitory computer-readable storage medium” encompasses only a computer-readable medium that can be considered to be a manufacture (i.e., article of manufacture) or a machine.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods as described herein need not reside on a single computer or processor, but may be distributed in a modular fashion amongst a number of different computers or processors to implement various aspects.

Computer-executable instructions may be in many forms, such as program modules, executed by one or more computers or other devices. Generally, program modules include routines, programs, objects, components, data structures, etc, that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Depending on the particular implementation and various associated factors such as the resources of the communications device, wireless network parameters, and other factors, different implementation architectures may be used for the present invention.

It should also be understood that the computer server may be implemented as one or more servers in any possible server architecture or configuration including for example in a distributed server architecture, a server farm, or a cloud based computing environment.

Wherever the system is described as receiving input from the user of the communications device, it is to be understood that the input may be received through activation of a physical key on the communications device, through interaction with a touch screen display of the communications device, through a voice command received at the communications device and processed by the system, through a user gesture observed and processed at the communications device, through physically moving the communications device in a predetermined gesture pattern including shaking the communications device, through receiving data from another local or remote communications device associated with the user, or through any other sensory interaction with the communications device or otherwise controlling the communications device.

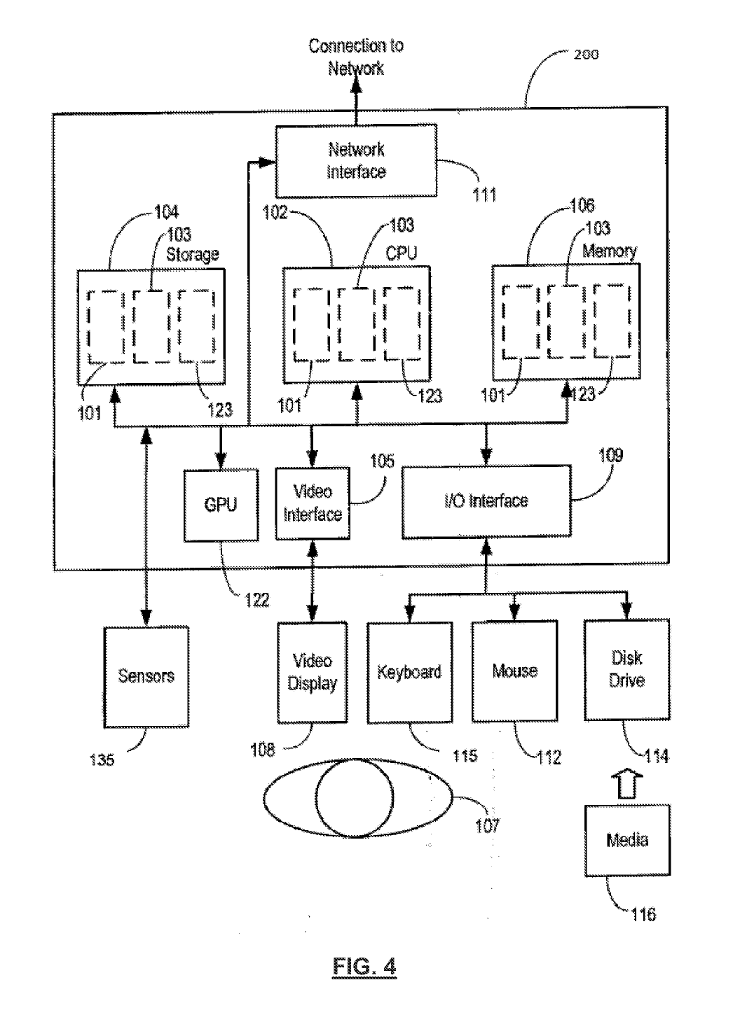

The present system and method may be practiced in various embodiments. A suitably configured computer device, and associated communications networks, devices, software and firmware may provide a platform for enabling one or more embodiments as described above. By way of example, FIG. 4 shows a generic computer device 200 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 200 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 200 may form part of a network via a network interface 111, allowing the computer device 200 to communicate with other suitably configured data processing systems (not shown). One or more different types of sensors 135 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The mobile application of the present invention may be implemented as a web service, where the mobile device includes a link for accessing the web service, rather than a native application.

The functionality described may be implemented to any mobile platform, including the iOS™ platform, ANDROID™, WINDOWS™ or BLACKBERRY™.

The embodiments described herein involve computing devices, servers, receivers, transmitters, processors, memory, display, networks particularly configured to implement various acts. The embodiments described herein are directed to electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, a various hardware components.

Substituting the computing devices, servers, receivers, transmitters, processors, memory, display, networks particularly configured to implement various acts for non-physical hardware, using mental steps for example, may substantially affect the way the embodiments work.

Such computer hardware limitations are clearly essential elements of the embodiments described herein, and they cannot be omitted or substituted for mental means without having a material effect on the operation and structure of the embodiments described herein. The computer hardware is essential to the embodiments described herein and is not merely used to perform steps expeditiously and in an efficient manner.

While illustrated in the block diagrams as groups of discrete components communicating with each other via distinct electrical data signal connections, the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching example embodiments.

It will be appreciated by those skilled in the art that other variations of the embodiments described herein may also be practiced without departing from the scope of the invention. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.
1. Lettieri C J, Eliasson A H, Andrada T et al. Obstructive sleep apnea syndrome: are we missing an at-risk population? J Clin Sleep Med 2005; 1: 381-5
2. Young T, Hutton R, Finn L et al. The gender bias in sleep apnea diagnosis: Are women missed because they have different symptoms? Arch Intern Med 1996; 156: 2445-51
3. Peppard P E, Young T, Barnet J H et al: Increased Prevalence of Sleep-Disordered Breathing in Adults. Am J Epidemiol 2013; 177: 1006-14
4 Young T, Evans L, Finn L et al. Estimation of the clinically diagnosed proportion of sleep apnea syndrome in middle aged men and women. Sleep 1997; 20:705-6
5. Singh M, Liao P, Kobah S et al. Proportion of surgical patients with undiagnosed obstructive sleep apnea. Br J Anaesth 2013; 110:629-636.
6. Finkel K J, Searleman A C, Tymkew H et al. Prevalence of undiagnosed obstructive sleep apnea among adult surgical patients in an academic medical center. Sleep Med 2009; 10: 753-8.

1. A computer system for determining an appropriate risk group of having obstructive sleep apnea (OSA) for an individual, the system comprising:
an electronic data store storing a plurality of user profiles and a questionnaire;
an input means for receiving one or more user inputs from a user related to the questionnaire; and
an analytics module configured to determine if the individual is obese or not based on the one or more user inputs, and further to determine the appropriate risk group of having OSA for the individual based on the one or more user inputs.

2. The computer system of claim 1, further comprising a client portal module configured to retrieve one or more parameters or one or more determinations of risk group of the individual.

3. The computer system of claim 1, wherein one of the one or more user inputs relates to a body mass index (BMI) and the analytics module is configured to determine if the individual is obese or not obese based on if said one of the one or more user inputs has a value greater than a pre-determined threshold.

4. The computer system of claim 1, wherein a risk level for the appropriate risk group is one of: a low risk, a high risk, and a very high risk.

5. The computer system of claim 1, wherein the analytics module is configured to determine the appropriate risk group of having OSA based on a total number of affirmative answers in the one or more user inputs to the questionnaire received by the input means.

6. The computer system of claim 1, wherein the questionnaire comprises one or more of:
(a) Do you Snore Loudly (loud enough to be heard through closed doors or your bed-partner elbows you for snoring at night)?
(b) Do you often feel Tired, Fatigued, or Sleepy during the daytime (such as falling asleep during driving)?
(c) Has anyone Observed you Stop Breathing or Choking/Gasping during your sleep?
(d) Do you have or are being treated for High Blood Pressure?
(e) Is your Body Mass Index (BMI) more than 35 kg/m²?
(f) Is your Age older than 50 year old?
(g) Neck size (measured around Adams Apple): For male, is your shirt collar 17 inches or larger? For female, is your shirt collar 16 inches or larger?
(h) Is your Gender Male?

7. The computer system of claim 6, wherein a set of STOP questions stored in the electronic data store comprises one or more of:
(a) Do you Snore Loudly (loud enough to be heard through closed doors or your bed-partner elbows you for snoring at night)?
(b) Do you often feel Tired, Fatigued, or Sleepy during the daytime (such as falling asleep during driving)?
(c) Has anyone Observed you Stop Breathing or Choking/Gasping during your sleep?
(d) Do you have or are being treated for High Blood Pressure?

8. The computer system of claim 7, wherein if the one or more user inputs indicate that the individual is not classified as obese, the appropriate risk group is determined to be a group of:
very high risk of OSA if the one or more user inputs comprise:
1) affirmative answers to 5 to 8 of the questions in the questionnaire;
2) affirmative answers to 2 or more of the STOP questions and the one or more user inputs indicate that the individual's gender is male; or
3) affirmative answers to 2 or more of the STOP questions, and the one or more user inputs indicate that the individual's BMI is greater than 35 kg/m²;
if the appropriate risk group is not determined to be the group of very high risk of OSA, then the appropriate risk group is determined to be a group of:
low risk of OSA if the one or more user inputs comprise affirmative answers to 0 to 2 questions in the questionnaire; or
high risk of OSA if the one or more user inputs comprise affirmative answers to 3 or 4 questions in the questionnaire.

9. The computer system of claim 7, wherein if the one or more user inputs indicate that the individual is classified as obese, the appropriate risk group is determined to be a group of:
very high risk of OSA if the one or more user inputs comprise:
1) affirmative answers to 6 to 8 of the questions; or
2) affirmative answers to 2 or more of the STOP questions and the one or more user inputs indicate that the individual's gender is male;
if the appropriate risk group is not determined to be the group of very high risk of OSA, then the appropriate risk group is determined to be a group of:
low risk of OSA if the one or more user inputs comprise affirmative answers to 0 to 3 questions in the questionnaire; or
high risk of OSA if the one or more user inputs comprise affirmative answers to 4 or 5 questions in the questionnaire.

10. The computer system of claim 8, wherein the analytics module classifies the individual as obese if the one or more user inputs indicate that the individual's BMI is greater than 35 kg/m².

11. A computer-implemented method for determining an appropriate risk group of having obstructive sleep apnea (OSA) for an individual, the method being performed by a processor, the processor in communication with a client application over a communication network, the method comprising:
(a) receiving, over the communication network, one or more user inputs in response to a questionnaire from the client application;
(b) determining if the individual is obese or not obese based on the one or more user inputs; and
(c) determining the appropriate risk group of having OSA for the individual based on the one or more user inputs.

12. The computer-implemented method of claim 11, further comprising storing at least one user profile for the individual in an electronic data store.

13. The computer-implemented method of claim 12, wherein determining if the individual is obese or not obese is based on if the one or more user inputs indicate that the individual has a body mass index (BMI) greater than a pre-determined threshold.

14. The computer-implemented method of claim 13, wherein a risk level for the appropriate risk group is one of: a low risk, a high risk, and a very high risk.

15. The computer-implemented method of claim 14, wherein determining the appropriate risk group of having OSA is based on a total number of affirmative answers in the one or more user inputs to the questionnaire received by the processor from the client application.

16. A computer-implemented method of assessing risk of OSA in an individual, the method comprising:
(a) receiving one or more user inputs to a questionnaire stored in an electronic data store; and
(b) determining, by an analytics module, the appropriate risk group for the individual based on the one or more user inputs.

17. The computer-implemented method of claim 16, wherein the questionnaire comprises one or more of:
(a) Do you Snore Loudly (loud enough to be heard through closed doors or your bed-partner elbows you for snoring at night)?
(b) Do you often feel Tired, Fatigued, or Sleepy during the daytime (such as falling asleep during driving)?
(c) Has anyone Observed you Stop Breathing or Choking/Gasping during your sleep?
(d) Do you have or are being treated for High Blood Pressure?
(e) Is your Body Mass Index (BMI) more than 35 kg/m²?
(f) Is your Age older than 50 year old?
(g) Neck size (measured around Adams Apple): For male, is your shirt collar 17 inches or larger? For female, is your shirt collar 16 inches or larger?
(h) Is your Gender Male?

18. The computer-implemented method of claim 17, wherein a set of STOP questions stored in the electronic data store comprises one or more of:
(a) Do you Snore Loudly (loud enough to be heard through closed doors or your bed-partner elbows you for snoring at night)?
(b) Do you often feel Tired, Fatigued, or Sleepy during the daytime (such as falling asleep during driving)?
(c) Has anyone Observed you Stop Breathing or Choking/Gasping during your sleep?
(d) Do you have or are being treated for High Blood Pressure?

19. The computer-implemented method of claim 18, wherein determining the appropriate risk group of having OSA for the individual based on the one or more user inputs comprises:
(a) if the one or more user inputs indicate that the individual is not classified as obese, the appropriate risk group is determined to be a group of:
very high risk of OSA if the one or more user inputs comprise:
1) affirmative answers to 5 to 8 of the questions in the questionnaire;
2) affirmative answers to 2 or more of the STOP questions and the one or more user inputs indicate that the individual's gender is male; or
3) affirmative answers to 2 or more of the STOP questions, and the one or more user inputs indicate that the individual's BMI is greater than 35 kg/m²;
if the appropriate risk group is not determined to be the group of very high risk of OSA, then the appropriate risk group is determined to be a group of:
low risk of OSA if the one or more user inputs comprise affirmative answers to 0 to 2 of the questions in the questionnaire; or
high risk of OSA if the one or more user inputs comprise affirmative answers to 3 or 4 of the questions in the questionnaire;
(b) if the individual is classified as obese, the appropriate risk group is determined to be a group of:
very high risk of OSA if the one or more user inputs comprise:
1) affirmative answers to 6 to 8 of the questions in the questionnaire; or
2) affirmative answers to 2 or more of the STOP questions and the one or more user inputs indicate that the individual's gender is male;
if the appropriate risk group is not determined to be the group of very high risk of OSA, then the appropriate risk group is determined to be a group of:
low risk of OSA if the one or more user inputs comprise affirmative answers to 0 to 3 of the questions in the questionnaire; or
high risk of OSA if the one or more user inputs comprise affirmative answers to 4 or 5 of the questions in the questionnaire.

20. The computer-implemented method of claim 19, wherein the analytics module determines the individual as obese if the one or more user inputs indicate that his or her BMI is greater than 35 kg/m².
